(19) United States
(12) Patent Application Publication
(10) Pub. No.: US 2013/0047951 A1
(43) Pub. Date: Feb. 28, 2013

(54) CRANKCASE

(71) Applicants: Thomas Flender, Eberdingen (DE); Michael Kreisig, Stuttgart (DE); Falk Schneider, Korntal-Muenchingen (DE); Stefan Steichele, Gerlingen (DE)

(72) Inventors: Thomas Flender, Eberdingen (DE); Michael Kreisig, Stuttgart (DE); Falk Schneider, Korntal-Muenchingen (DE); Stefan Steichele, Gerlingen (DE)

(21) Appl. No.: 13/594,514

(22) Filed: Aug. 24, 2012

(30) Foreign Application Priority Data
Aug. 24, 2011 (DE) 102011081486.8

(51) Int. Cl. F02F 7/00; B23P 11/02

(52) U.S. Cl. 123/195 R; 29/447

(57) ABSTRACT

The present invention relates to a crankcase (1) with a camshaft (4) mounted therein via rolling bearings (3) in a bearing tunnel (2),
at least a part of a respective rolling bearing (3) is thermally joined to the camshaft or to the crankcase (1),
the bearing tunnel (2) of the crankcase (1) is exclusively worked in the region (12) of the rolling bearings (3).

Because of this, the camshaft (4) on the one hand can be mounted more easily and on the other hand can be easily installed in the crankcase (1).

### CROSS-REFERENCE TO RELATED APPLICATIONS

This application claims priority to German Patent Application No. 102011081486.8 filed on Aug. 24, 2011, the contents of which are hereby incorporated by reference in their entirety.

### TECHNICAL FIELD

The present invention relates to a crankcase with a camshaft mounted therein via rolling bearings in a bearing tunnel. The invention additionally relates to a combustion engine having such a crankcase.

### BACKGROUND

Camshafts are used in combustion engines for controlling the inlet and exhaust valves and have cams for this purpose, which actuate the associated inlet valve or exhaust valve via a valve drive. Such camshafts are usually mounted in suitable bearing pedestals via sliding bearings, the bearing pedestals having to be individually aligned in order to be able to guarantee an easy operation of the camshaft. The bearing pedestals in turn are connected to the cylinder head, that is with a cylinder crankcase, in particular, screwed to it, wherein during the tightening of this screw connection an alignment of the individual bearing eyes of the bearing pedestals has to be taken into account without fail. The sliding bearings normally used for mounting camshafts additionally need an exactly defined lubrication in order to be able to achieve the desired, good bearing characteristics.

### SUMMARY

The present invention deals with the problem of stating an improved embodiment for a crankcase, which is characterized in particular through an easy mounting of a camshaft and a simplified assembly as well as by a reduced manufacturing effort.

According to the invention, this problem is solved through the subjects of the independent claims. Advantageous embodiments are subject of the dependent claims.

The invention is based on the general idea of mounting a camshaft in a bearing tunnel via rolling bearings, that is for example via ball bearings or needle bearings and thus in a comparatively easy-operating manner, and to join these rolling bearings to the camshaft and/or the crankcase in a thermal manner prior to the actual assembly of the camshaft in the bearing tunnel. Through the fact that the bearing tunnel of the crankcase according to the invention is exclusively worked or reworked in the region of the rolling bearings, the manufacturing effort of the crankcase can be clearly reduced, since this need no longer be worked or reworked along the entire bearing tunnel as before, but exclusively still in those regions, in which the rolling bearings are actually arranged subsequently. Through the thermal joining of the rolling bearings to the camshaft and/or the crankcase a comparatively simple fastening of the rolling bearings is additionally provided. For the thermal joining of the rolling bearing to the camshaft, the bearing is heated and/or the camshaft cooled down, whereas during the thermal joining of the rolling bearing to the crankcase, the crankcase is heated and/or the respective rolling bearing is cooled down. In principle, it is also conceivable that the rolling bearing is initially joined thermally to the camshaft, for example to a camshaft module and subsequently a thermal joining of this camshaft module to the crankcase through for example heating of the crankcase and/or cooling of the camshaft module is carried out. By replacing sliding bearings previously used in this bearing with the rolling bearings according to the invention, the camshaft can be mounted significantly more easily, which is likely to be reflected in a reduced fuel consumption and an improved CO₂ balance in motor vehicles.

With an advantageous further development of the solution according to the invention, the bearing tunnel comprises at least one radial step and tapers in pushing-in direction of the camshaft into the crankcase. Through such a radial step, rolling bearings which are different in size and thus also different in performance can be used, so that it is conceivable for example that in the region of a chain wheel/belt pulley a comparatively large and thus high-performance rolling bearing is arranged, whereas on an end of the camshaft facing away from the chain wheel/belt pulley merely a comparatively small rolling bearing is arranged. Through the at least one radial step and the bearing tunnel tapering in pushing-in direction of the camshaft, the camshaft can be simply pushed into the bearing tunnel and fixed there. Here, the bearing tunnel tapers in pushing-in direction similar to a pine tree. During the installation of the camshaft in the crankcase, the individual rolling bearings are positioned exactly at those points at which the bearing tunnel was previously worked, for example reworked, in particular honed in order to be able to guarantee a perfect and optimal seat of an outer race of the rolling bearing in the bearing tunnel in this region.

Practically, the crankcase is embodied unitarily. In order to be able to further reduce an assembly effort, the crankcase according to the invention is produced unitarily, i.e. from one piece or one casting, as a result of which in particular separate assembly steps for producing the crankcase can be omitted. Here, materials such as for example light metals, for example aluminium or magnesium but also iron are possible. The unitary embodiment of the crankcase can for example be realised through suitable sand cores or sand moulds.

With a further advantageous embodiment of the solution according to the invention, a locking pin that can be moved against an outer race of the rolling bearing and fixed can be provided, which can optionally engage in a circumferential groove of the outer race of the rolling bearing and thus fix the latter in axial direction. Here, the locking pin can be designed for example in the manner of a grub screw or merely in the manner of a pin and is clamped against the outer race of the rolling bearing and thus against the rolling bearing proper, as a result of which said rolling bearing can be fixed in the bearing tunnel in axial direction. If the outer race of the rolling bearing additionally comprises a circumferential groove that is open to the outside, the locking pin can comprise a head formed complementarily to the groove geometry, with which it engages in the circumferential groove of the outer race, thus fixing the rolling bearing at least in axial direction. Fixing in radial direction is not likely to be necessary in all probability since the rolling bearing with its outer race is positioned free of play or merely with defined little play in the bearing tunnel of the crankcase. For removing the camshaft, for example for maintenance purposes, the locking pin thus has to be removed initially and because of this an axial movement of the rolling bearing locked by said locking pin, permitted. Such locking pins can be conceivable in almost any embodiment. Such a locking pin need not be generally provided for any camshaft and any crankcase, but can be reserved for example for camshaft and crankcase with high axial forces.

Further important features and advantages of the invention are obtained from the subclaims, from the drawing and from the associated FIGURE description by means of the drawing.

It is to be understood that the features mentioned above and still to be explained in the following cannot only be used in the respective combination stated but also in other combinations or by themselves, without leaving the scope of the present invention.

### BRIEF DESCRIPTION OF THE DRAWINGS

A preferred exemplary embodiment of the invention is shown in the drawing and is explained in more detail in the following description.

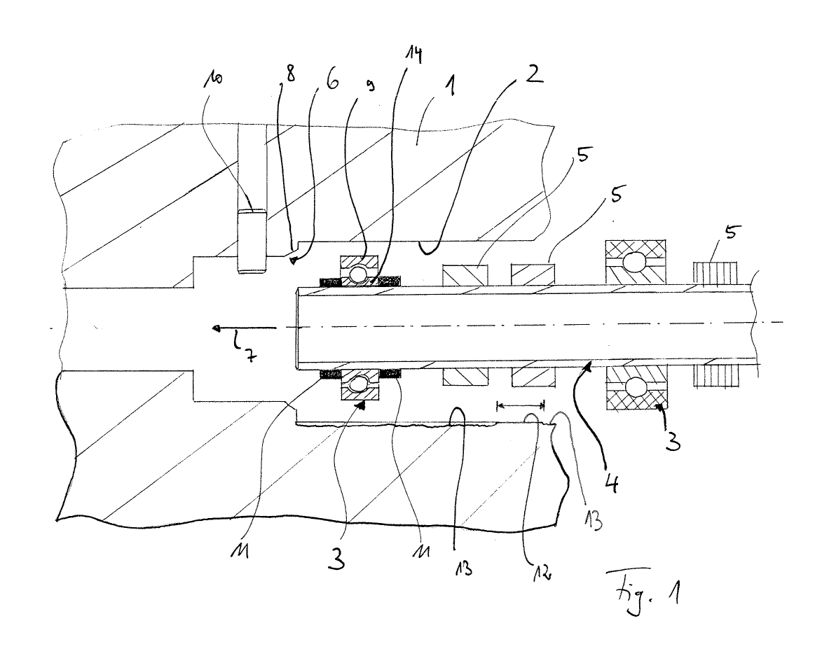

The only FIG. 1 shows a sectional representation through a crankcase according to the invention with an associated camshaft.

### DETAILED DESCRIPTION

According to FIG. 1, a crankcase 1 according to the invention comprises a camshaft 4 mounted in a bearing tunnel 2 via rolling bearings 3. In order to be able to make the production of the crankcase 1 on the one hand less involved and thus more cost effective and on the other hand to be able to mount the camshaft 4 in as easy to operate and thus fuel-saving a manner as possible, the bearing tunnel 2 of the crankcase 1 is exclusively worked in the region 12 of the rolling bearings 3 and for example ball bearings or needle bearings selected as rolling bearings 3. In known manner, the camshaft 4 comprises cams 5 arranged on said camshaft, which activate inlet and exhaust valves of a combustion engine which is not shown.

According to FIG. 1, the rolling bearings 3 are designed as ball bearings and are thermally joined to the camshaft 4. Obviously, it is also conceivable here that the rolling bearings 3 are thermally joined to the crankcase, that is in the bearing tunnel 2. Alternatively to this it is also conceivable that upon a formation of the rolling bearing 3 as needle bearing, an outer race 9 of the rolling bearing 3 is thermally joined to the bearing tunnel 2 of the crankcase 1 and an inner race 14 of the rolling bearing 3 is thermally joined to the camshaft 4. Through the thermal joining, a connection that is comparatively simple and has been tested over many years can be achieved between the rolling bearing 3 on the one hand and the camshaft 4 or the crankcase 1 on the other hand.

In principle it is also conceivable that the rolling bearing 3 is initially joined thermally to the camshaft 2, for example to a camshaft module and subsequently a thermal joining of this camshaft module to the crankcase 1 is carried out through for example heating of the crankcase 1 and/or cooling of the camshaft module. Here, the camshaft module can be fixed during the thermal joining in the crankcase 1 up to a temperature equalisation. “Temperature equalisation” in this case means an approximation of the temperatures of the camshaft module and of the crankcase, at least for as long as the thermal joining connection fixes the camshaft module in the crankcase.

Through the fact that the bearing tunnel 2 is exclusively worked or reworked in those regions 12 in which the rolling bearings 3 are arranged later on, the regions 13 located in between can remain unworked, and because of this the manufacturing effort of the crankcase 1, significantly reduced.

Looking at FIG. 1, it is noticeable that the bearing tunnel 2 has at least one radial step 6 and tapers in pushing-in direction 7 of the camshaft 4. In this context, this is also called a pine tree structure with steps 6. Because of this it is possible to provide rolling bearings 3 appropriate to the load, for example a comparatively large and because of this—performance rolling bearing 3 in the region of a chain wheel/belt pulley which is not shown, wherein on a longitudinal end of the camshaft 4 facing away from the chain wheel/belt pulley a merely comparatively small and thus lower-performance rolling bearing 3 is provided. An edge of the radial step 6 can have a chamfer 8, in order to be able to largely exclude damages during the pushing-in of the camshaft 4 into the bearing tunnel 2.

For the axial locking of the camshaft 4 in the bearing tunnel 2 a locking pin 10 that can be moved against the outer race 9 of the rolling bearing 3 and fixed can be provided in the crankcase 1, wherein optionally on the outer race 9 of the rolling bearing 3 a circumferential groove that is open towards the outside can be additionally provided, in which the locking pin 10, for example with a head formed complementarily to the groove geometry, engages and because of this, fixes the rolling bearing 3 in axial direction. With the locking pin 10 shown according to FIG. 1, such a head is not provided, so that this locking pin 10 presses linearly or areally against the outer race 9 of the rolling bearing 3. Here, the locking pin 10 can be formed as pin in the actual sense but also as a grub screw. Obviously, it is also conceivable that the locking pin 10 does not act on the outer race 9 of the rolling bearing 3, but is pushed in or turned in adjacent to the rolling bearing 3, for example in pushing-in direction 7 behind the latter, and because of this forms the required axial locking.

On at least one of the rolling bearings 3, two adjacent locking rings 11 can be arranged for locking said rolling bearing 3 in axial direction, which are for example likewise thermally joined to the camshaft 4. According to the invention, the crankcase 1 can be embodied unitarily or even in one piece, for example from light metal as in particular aluminium, wherein previously required bearing pedestals, which have to be assembled separately and thus elaborately, can be omitted.

Looking at the lower side of the bearing tunnel 2, one can see in this region 12 that the bearing tunnel 12 is worked in order to be able to offer a perfect contact of the outer race 9 of the rolling bearing 3. In the regions 13 arranged adjacently, such working is not required, as a result of which the working of the crankcase 1 altogether can involve less effort. The unworked region 13 in this case is represented exaggerated with respect to its roughness in order to be able to emphasise the advantages of the invention. The region 12 usually extends in the manner of a ring about the rolling bearing 3 in its subsequent installation position and is thus obviously present in a circumferential manner on all sides of the bearing tunnel 2.

With the crankcase 1 according to the invention and the inserted rolling bearings 3, the camshaft 4 can be mounted in a comparatively easily operated and thus fuel-saving manner, wherein in addition the assembly of the camshaft 4 in the crankcase 1 is simplified, since previously required bearing pedestals, which would have to be aligned separately, can be omitted.

1. A crankcase with a camshaft mounted via rolling bearings therein in a bearing tunnel, and comprising:
at least a part of a respective rolling bearing being thermally joined to at least one of the camshaft and the crankcase, and
the bearing tunnel of the crankcase being exclusively worked in the region of the rolling bearings.

2. The crankcase according to claim 1, wherein the rolling bearings are designed as at least one of ball bearings and needle bearings.

3. The crankcase according to claim 1, wherein the bearing tunnel comprises at least one radial step and tapers in a pushing-in direction of the camshaft.

4. The crankcase according to claim 3, wherein at least two different-size rolling bearings are provided, which bear against different radial steps of the crankcase.

5. The crankcase according to claim 1, wherein the crankcase is embodied unitarily.

6. The crankcase according to claim 1, wherein in the crankcase a locking pin is moveable and fixable against an outer race of the associated rolling bearing.

7. The crankcase according to claim 6, wherein the locking pin engages into a circumferential groove of the outer race of the rolling bearing, thereby, fixing the latter in an axial direction.

8. The crankcase according to claim 1, wherein on at least one rolling bearing for locking in axial direction, two adjacent locking rings are provided on the camshaft.

9. A combustion engine with a crankcase according to claim 1.

10. A method for the assembly of a camshaft in a crankcase of a combustion engine comprising:
initially joining thermally a rolling bearing to the camshaft into a camshaft module, and
thermally joining the camshaft module to the crankcase, by at least one of heating the crankcase and cooling the camshaft module.

11. The method according to claim 10, further comprising fixing the camshaft module during the thermal joining in the crankcase up to a temperature equalisation.

12. The method according to claim 10, further comprising:
mounting a camshaft via rolling bearings therein in a bearing tunnel; and
exclusively working a bearing tunnel in the region of the rolling bearings.

13. The method according to claim 12, further comprising fixing the camshaft module during the thermal joining in the crankcase up to a temperature equalisation.

14. The crankcase according to claim 4, wherein the crankcase is embodied unitarily.

15. The crankcase according to claim 14, wherein in the crankcase a locking pin is moveable and fixable against an outer race of the associated rolling bearing.

16. The crankcase according to claim 4, wherein the crankcase a locking pin is moveable and fixable against an outer race of the associated rolling bearing.

17. The crankcase according to claim 3, wherein the crankcase a locking pin is moveable and fixable against an outer race of the associated rolling bearing.

18. The crankcase according to claim 3, wherein on at least one rolling bearing for locking in axial direction, two adjacent locking rings are provided on the camshaft.

19. The crankcase according to claim 18, wherein in the crankcase a locking pin is moveable and fixable against an outer race of the associated rolling bearing.

20. The crankcase according to claim 19, wherein the locking pin engages into a circumferential groove of the outer race of the rolling bearing, thereby fixing the latter in an axial direction.
